(19) United States
(12) Patent Application Publication
(10) Pub. No.: US 2018/0000566 A1
(43) Pub. Date: Jan. 4, 2018

(54) SCANNING BODY SYSTEM FOR DETERMINING A POSITIONING AND ORIENTATION OF A DENTAL IMPLANT

(71) Applicant: NT-TRADING GMBH & CO. KG, Karlsruhe (DE)

(72) Inventor: Dirk JAHN, Weyher (DE)

(21) Appl. No.: 15/543,757

(22) PCT Filed: Jan. 15, 2016
(86) PCT No.: PCT/EP2016/050754

§ 371 Date: Jul. 14, 2017

(30) Foreign Application Priority Data
Jan. 26, 2015 (DE) 20 2015 000 801.1

(51) Int. Cl. A61C 8/00; A61C 9/00

(52) U.S. Cl. CPC A61C 8/0001; A61C 9/004

(57) ABSTRACT

A scanning body system for determining a positioning and orientation of a dental implant, including a base part, an interface, and a scanning part which has a three-dimensional scanning contour and is rigidly connected to the base part to form a scanning body, and a fastening screw, provided for fastening the scanning body in the dental implant. Provision is made that the base part and/or the fastening screw are provided with at least one mechanical retention arrangement, which holds the fastening screw securely in the scanning body after insertion into the scanning body through a passage of the scanning part.

The invention relates to a scanning body system for determining a positioning and orientation of a dental implant, with a base part comprising an interface, and with a scanning part which has a three-dimensional scanning contour and is firmly connected to the base part to form a scanning body, and with a fastening screw which is provided for fastening the scanning body in the dental implant.

Such a scanning body system is disclosed in DE 20 2013 005 821 U1. The known scanning body system includes a scanning body comprising a base part and a scanning part which are produced as separate components made of different materials and subsequently compressed to obtain the scanning body. Prior to joining the base part and the scanning part, a fastening screw is inserted into a locating channel of the base part, which screw is captively held in the scanning body after force-fitted joining of the base part and the scanning part. The scanning part includes, on the top side facing away from the base part, a passage towards an interior of the scanning part, wherein the fastening screw is positioned. The passage is to allow passing of a tool in order to turn the fastening screw. A cross section of the passage is smaller than a passage of a screw head of the fastening screw so that the fastening screw is captively held in the scanning body after joining of the base part and the scanning part.

An object of the invention is to provide a scanning body system of the type mentioned in the introduction, which has improved functional options as compared to the prior art.

This object is achieved in that the base part and/or the fastening screw are/is provided with at least one mechanical retaining means which holds the fastening screw, after inserting through a passage of the scanning part into the scanning body, captively within the scanning body. The scanning body system according to the invention allows separate storage and handling of scanning body and fastening screw. Nevertheless, after inserting into the scanning body, the fastening screw is held captively within the scanning body so that inadvertent loss of the fastening screw, in particular during intraoral application of the scanning body system, is prevented.

In an embodiment of the invention, the retaining means are designed such that the fastening screw, after inserting into the scanning body, can be removed from the scanning body later on. As compared to the prior art, this feature allows improved cleaning capability of the scanning body system. Namely, the possible removal of the fastening screw from the scanning body offers an improved feasibility of cleaning the interior of the scanning body. As a result, the scanning body system allows a particularly hygienic multiple usage.

In a further embodiment of the invention, the passage of the scanning part is provided on an end side facing away from the base part, and a cross section of the passage is equal to or greater than a greatest cross section of the fastening screw. Thereby, it is ensured that the fastening screw can be inserted from the exterior through the passage of the scanning part into the interior of the scanning body.

In a further embodiment of the invention, the mechanical retaining means is provided on an outer circumference of the fastening screw or on an inner circumference of a locating channel of the base part surrounding the fastening screw. The mechanical retaining means preferably gives force-fitting or form-fitting support for the fastening screw. Across and through the scanning part of the scanning body, the fastening screw can both be inserted from the exterior and, after inserting, again be removed towards the exterior.

In a further embodiment of the invention, the mechanical retaining means is integrally molded to the inner circumference of the locating channel. With particular advantage, the retaining means is an internal thread section on the inner circumference of the locating channel complementary to an external thread of the fastening screw. The integral molding, in particular the configuration of an internal thread section, is feasible in a simple and cost-efficient manner.

In a further embodiment of the invention, the retaining means is embodied in an elastically resilient annular portion protruding radially outwards beyond an outer contour of the fastening screw. The elastically resilient annular portion can be disposed on the fastening screw in material-bonding engagement, in particular by vulcanizing or adhesively bonding. As an alternative, the elastically resilient annular portion can be designed by at least one separately manufactured elastic annular structure connected to the outer contour of the fastening screw in a force-fitting or form-fitting manner.

In a further embodiment of the invention, the annular portion includes an 0-ring made of an elastomer material, which ring is held in an annular groove of the fastening screw. Advantageously, the annular groove is provided on a screw head of the fastening screw. The annular groove can be worked in the screw head of the fastening screw by machining. The elastically resilient O-ring can, subsequently, be elastically enlarged and inserted into the annular groove by simple ways and means. What is meant by elastomer material are as well materials made of synthetic or natural rubber and also materials made of thermoplastic elastomers.

Further advantages and features of the invention will become apparent from the claims and from the description below of preferred exemplary embodiments of the invention which are illustrated with reference to the drawings.

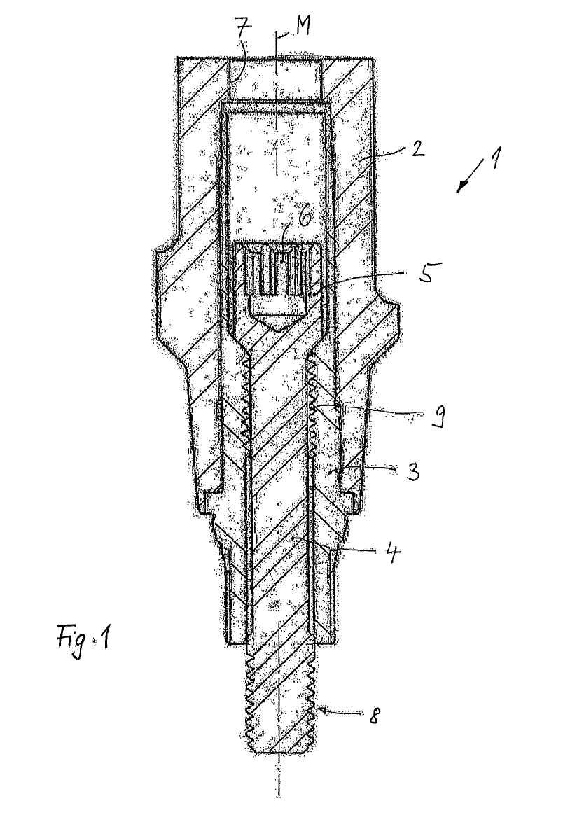

FIG. 1 shows a sectional view of a first embodiment of a scanning body system according to the invention; and

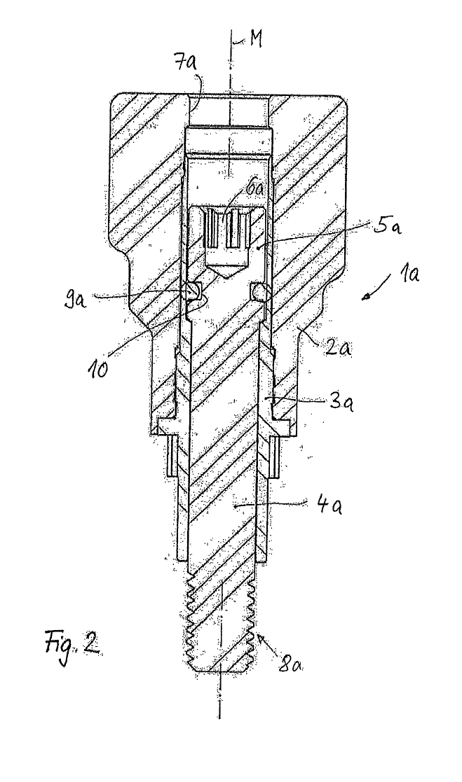

FIG. 2 shows, likewise in a sectional view, another embodiment of a scanning body system according to the invention.

Both scanning body systems 1 and 1a according to FIGS. 1 and 2 exhibit principally the same structural design. Thus, parts or portions of the scanning body systems 1, 1a of similar functionality are provided with the same reference numerals, however, in relation to the embodiment according to FIG. 2 with the letter “a” added. Both the scanning body systems 1, 1a each include a scanning body composed of a scanning part 2 and a base part 3. Each base part 3, 3a is made of a metallic material, preferably a titanium alloy. Each scanning part 2 is molded of a synthetic material, in the present case made of PEEK, and has in the region of its outer contour a plurality of scanning surfaces of different design, which are arranged distributed over a circumference of the scanning part 2 and define a three-dimensional scanning contour. The scanning part 2, 2a and the base part 3, 3a are firmly connected to each other by coaxial joining lengthwise a central longitudinal axis M. Joining is in a force-fitting manner by pressing the base part 3, 3a into the scanning part 2. For that purpose, the scanning part 2, 2a is provided with a seat that is open towards opposite end sides, which seat leads, on a side remote from the base part 3, 3a, into a passage 7, 7a that will be described in more detail below. Mutually facing contact surfaces of the base part 3, 3a on the one hand and the scanning part 2, 2a on the other hand can additionally be provided with latching profilings, in order to further improve cohesion between scanning part 2, 2a and base part 3, 3a after compression.

Owing to the joining of the scanning part 2, 2a to the base part 3, 3a, a scanning body to be handled as one structural unit is obtained, which scanning body is capable of being inserted into a dental implant (not illustrated) and capable of being positioned within the dental implant in a non-rotating manner by means of an interface (not illustrated in more detail) on a section of the base part 3, 3a protruding beyond the scanning part 2, 2a opposite to the passage 7, 7a. The interface on the, in relation to the scanning part 2, 2a, lower end section of the base part 3, 3a is provided with rotationally asymmetric profilings on the outer circumference thereof, which are matched to complementary inner profilings of the dental implant.

Moreover, the scanning body system 1, 1a includes a fastening screw 4, 4a which is provided with a screw head 5, 5a on an upper face end region and with an external thread 8, 8a on an opposite face end region. The external thread 8, 8a has a configuration complementary to an internal thread of the dental implant, in order to allow screwing in and out of the fastening screw 4, 4a relative to the dental implant.

The screw head 5, 5a of the fastening screw 4, 4a has a cylindrical design and a diameter which is greater than a cylindrical screw shaft of the respective fastening screw 4, 4a, with the external thread 8, 8a provided on the lower face end region thereof. However, the diameter of the screw head 5, 5a of the fastening screw 4, 4a is smaller than or equal to a diameter of the passage 7, 7a on the upper face end region of the scanning part 2, 2a. This feature allows that the fastening screw 4, 4a can be stored and handled separate from the scanning body 2, 3; 2a, 3a. The fastening screw 4, 4a is driven through the passage 7, 7a of the scanning part 2, 2a from above coaxially in relation to the central longitudinal axis M of the scanning body 2, 3; 2a, 3a for a ready-for-use assembly of the scanning body system 1, 1a.

In the embodiment according to FIG. 1, an internal thread section 9 is provided on an inner circumference of a locating channel of the base part 3 extending within the scanning part 2 on an upper section remote from the interface, which thread section serves as mechanical retaining means for securing the fastening screw 4 in the scanning body 2, 3. The internal thread section 9 has a configuration complementary to the external thread 8 of the fastening screw 4. After inserting the fastening screw 4 from above across and through the passage 7, the external thread 8 meets the internal thread section 9 of the base part 3. By means of simple screwing in of the fastening screw 4 using a tool engaging the tool engagement surfaces 6, the fastening screw 4 can be screwed through the internal thread section 9. The internal thread section 9 extends merely over approximately one third of the axial length of the locating channel of the base part 3 (not illustrated in more detail) so that the fastening screw 4, after screwing the external thread 8 through the internal thread section 9, is again axially movable. However, the internal thread section 9 prevents that the fastening screw 4 can be pushed back out of the passage 7 axially upwards. Indeed, removing of the fastening screw 4 is possible merely in that the fastening screw 4 is initially pushed back axially upwards, until the external thread 8 abuts on a lower edge of the internal thread section 9. Subsequently, the screw has to be screwed out axially upwards via said internal thread section 9, before it comes clear and can be withdrawn completely to the outside.

In the embodiment according to FIG. 2, the base part 3a does not have an internal thread section within its locating channel. Rather, the locating channel has a cylindrical design so that the fastening screw 4a and its screw shaft can be shifted axially within said locating channel. The mechanical retaining means of the fastening screw 4a is created by a radially elastically resilient O-ring 9a which is held in an annular groove 10 integrally molded in the screw head 5a. A depth of the annular groove 10 is embodied such that the O-ring can be pressed in elastically far enough that it does no longer protrude beyond an outer contour of the screw head 5a of the fastening screw. The elastic pre-tensioning of the O-ring 9a is such that the O-ring 9a is always urged radially outwards and, thus, allows force-fitting support of the fastening screw 4a in the base part 3a and in the scanning part 2a.

Since the diameter of the screw head 5a is smaller than or equal to the passage 7a of the scanning part 2a, the fastening screw 4a can be pushed in axially from above into the scanning body 2a, 3a. Once the O-ring 9a, which is retained in the annular groove 10, comes to abut on an upper face end edge of the passage 7a and, owing to the elastic resilience of the O-ring, the ring is urged inwards into the annular groove 10, whereby the fastening screw 4a can slide further downwards. The radially outwards acting elastic tension of the O-ring 9a is sufficient in order to retain the fastening screw 4a in the scanning body 2a, 3a. Moreover, a radially outwards enlarged annular step is provided between the passage 7a and the adjacent seat of the scanning part 2a for the base part 3a such that, during an axial shifting of the fastening screw 4a, the O-ring 9a is additionally supported towards the top on said annular step in a form-fitting manner. However, in the case as illustrated in FIG. 2, with the fastening screw 4a in an inserted condition, if an axial force acts from below, i.e. from an end side facing the external thread 8a, upwards onto the fastening screw 4a, the O-ring 9a is again elastically and radially urged back inwards in the region of the annular shoulder and can slide upwards through the passage 7a, whereby the fastening screw 4a can be axially withdrawn from the seat in the scanning body 2a, 3a. Said withdrawal, i.e. removal of the fastening screw 4, 4a, allows a particularly facilitated and hygienic cleaning of the interior of the remaining scanning body 2, 3; 2a, 3a with both scanning body systems 1, 1a. Moreover, even the fastening screw 4, 4a as such can be cleaned by simple ways and means, while it is detached from the scanning body 2, 3; 2a, 3a.

1. Scanning body system for determining a positioning and orientation of a dental implant, with a base part comprising an interface, and with a scanning part which has a three-dimensional scanning contour and is firmly connected to the base part to form a scanning body, and with a fastening screw which is provided for fastening the scanning body in the dental implant,
wherein
the base part and/or the fastening screw are/is provided with at least one mechanical retaining means which holds the fastening screw, after inserting through a passage of the scanning part into the scanning body, captively within the scanning body.

2. Scanning body system according to claim 1, wherein the at least one retaining means is designed such that the fastening screw, after inserting into the scanning body, can be removed from the scanning body later on.

3. Scanning body system according to claim 1, wherein the passage of the scanning part is provided on an end side facing away from the base part, and in that a cross section of the passage is equal to or greater than a greatest cross section of the fastening screw.

4. Scanning body system according to claim 1, wherein the mechanical retaining means is provided on an outer circumference of the fastening screw or on an inner circumference of a locating channel of the base part surrounding the fastening screw.

5. Scanning body system according to claim 1, wherein the mechanical retaining means is integrally molded to the inner circumference of the locating channel of the base part.

6. Scanning body system according to claim 5, wherein the retaining means is an internal thread section on the inner circumference of the locating channel complementary to an external thread of the fastening screw.

7. Scanning body system according to claim 1, wherein the retaining means is an elastically resilient annular portion protruding radially outwards beyond an outer contour of the fastening screw.

8. Scanning body system according to claim 7, wherein the annular portion includes an O-ring made of an elastomer material, which ring is held in an annular groove of the fastening screw.

9. Scanning body system according to claim 8, wherein the annular groove is provided on a screw head of the fastening screw.
